(19) United States
(12) Patent Application Publication
(10) Pub. No.: US 2025/0383989 A1
(43) Pub. Date: Dec. 18, 2025

(54) NON-CONTIGUOUS ATTENTION MASK FOR KEY-VALUE (KV) CACHE MANAGEMENT FOR FIXED-LENGTH TRANSFORMER MODELS

(71) Applicant: QUALCOMM Incorporated, San Diego, CA (US)

(72) Inventor: Pranav SHRESTHA, San Diego, CA (US)

(21) Appl. No.: 18/743,010

(22) Filed: Jun. 13, 2024

(51) Int. Cl. G06F 12/0802

(52) U.S. Cl. CPC G06F 12/0802; G06F 2212/454

(57) ABSTRACT

A processor-implemented method includes constructing a non-contiguous attention mask corresponding to selected key-value (KV) vectors non-contiguously stored in a KV cache buffer. The method also includes multiplying the non-contiguous attention mask with the KV cache buffer to obtain token-specific KV vectors. The method further includes generating a new KV vector, with an artificial neural network transformer model during a current inference iteration, based on an input token and the token-specific KV vectors. The method may also append the new KV vector into an input buffer of the KV cache buffer adjacent to right-side padding during a next inference iteration with the artificial neural network transformer model.

### FIELD OF THE DISCLOSURE

Aspects of the present disclosure generally relate to artificial neural network memory management, and more specifically to a non-contiguous attention mask for key-value (KV) cache management for fixed-length transformer models.

### BACKGROUND

Artificial neural networks may comprise interconnected groups of artificial neurons (e.g., neuron models). The artificial neural network (ANN) may be a computational device or be represented as a method to be performed by a computational device. Various ANN model structures are available for consideration. Convolutional neural networks (CNNs) are a type of feed-forward ANN. Convolutional neural networks may include collections of neurons that each have a receptive field and that collectively tile an input space.

A transformer ANN structure makes use of attention mechanisms that may enable the model to process input sequences in a parallel and efficient manner. An attention mechanism allows the model to focus on different parts of the input sequence at different times. A transformer ANN structure may be of particular use for tasks that involve sequence modeling, such as text generation by a large language model (LLM). An improved attention mechanism for a transformer ANN structure would be desirable.

### SUMMARY

In aspects of the present disclosure, a processor-implemented method includes constructing a non-contiguous attention mask corresponding to selected key-value (KV) vectors non-contiguously stored in a KV cache buffer. The method also includes multiplying the non-contiguous attention mask with the KV cache buffer to obtain token-specific KV vectors. The method further includes generating a new KV vector, with an artificial neural network transformer model during a current inference iteration, based on an input token and the token-specific KV vectors.

Other aspects of the present disclosure are directed to an apparatus. The apparatus has one or more memories and one or more processors coupled to the one or more memories. The processor(s) is configured to construct a non-contiguous attention mask corresponding to selected key-value (KV) vectors non-contiguously stored in a KV cache buffer. The processor(s) is also configured to multiply the non-contiguous attention mask with the KV cache buffer to obtain token-specific KV vectors. The processor(s) is further configured to generate a new KV vector, with an artificial neural network transformer model during a current inference iteration, based on an input token and the token-specific KV vectors.

In other aspects of the present disclosure, a non-transitory computer-readable medium with program code recorded thereon is disclosed. The program code is executed by a processor and includes program code to construct a non-contiguous attention mask corresponding to selected key-value (KV) vectors non-contiguously stored in a KV cache buffer. The program code also includes program code to multiply the non-contiguous attention mask with the KV cache buffer to obtain token-specific KV vectors. The program code further includes program code to generate a new KV vector, with an artificial neural network transformer model during a current inference iteration, based on an input token and the token-specific KV vectors.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIG. 2 is an illustrative block diagram of an example machine learning (ML) model represented by an artificial neural network (ANN), in accordance with aspects of the present disclosure.

FIG. 3 is a block diagram illustrating an exemplary software architecture that may modularize artificial intelligence (AI) functions, in accordance with aspects of the present disclosure.

FIG. 4A illustrates a technique for creating a contiguous key-value (KV) cache with left padding.

FIG. 4B illustrates a first option for creating a contiguous KV cache with right padding.

FIG. 4C illustrates a second option for creating a contiguous KV cache with right padding.

FIG. 5 illustrates a first technique for creating a contiguous cache with left padding.

FIG. 6 illustrates a second technique for creating a contiguous cache with left padding.

FIG. 7 illustrates right padding KV cache management, in accordance with aspects of the present disclosure.

FIG. 8A is a block diagram illustrating a non-contiguous attention mask for right padding, according to aspects of the present disclosure.

FIG. 8B is a block diagram illustrating a non-contiguous attention mask for right padding, according to aspects of the present disclosure.

FIG. 9 is a block diagram illustrating transformer model inputs and outputs, and masking by a non-contiguous attention mask, in accordance with aspects of the present disclosure.

FIG. 10 is a flow diagram illustrating a processor-implemented method for operating a transformer model with a non-contiguous attention mask, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feed-forward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, such as text generation with a large language model (LLM).

LLM token generation requires the use of key-value cache (KV$) to store intermediate calculations. Due to the various restrictions, including memory limitations and the static nature of existing compiler frameworks, the KV cache is implemented as a left-padded buffer. Adding newly generated KV vectors to the KV cache requires a left-shift of the existing buffer, either by pointer manipulation or direct memory movement (e.g., the operation ‘std::memmove’). The memmove approach causes a high CPU load resulting in increased latency and thermal inefficiency, while pointer manipulation requires smaller CPU loads but extra memory usage.

Aspects of the present disclosure introduce a non-contiguous attention mask for KV cache management. The non-contiguous attention mask allows the KV cache to be implemented as a right-padded buffer, and eliminates the need for left-shifting of the existing buffer. A well-constructed non-contiguous attention mask allows KV cache tensors to be non-contiguous. The KV cache buffer may be implemented as a right-padded buffer, with the oldest KV vector values at the beginning of the buffer, and subsequent KV vector values positioned sequentially to the right. Similar to a left-padded design, each input token only attends to itself and its past context (e.g., the nth input token Tn attends to KV vectors KV₀, KV₁, . . . , KVₙ₋₁).

Aspects of the present disclosure apply to any inference on a fixed-length transformer model (e.g., where the context size is fixed). These aspects apply to static shape compiler designs where tensors are static in shape once the model is compiled.

Particular aspects of the subject matter described in this disclosure can be implemented to realize one or more of the following potential advantages. In some examples, the described non-contiguous attention mask allows non-contiguous KV vectors in the KV cache without sacrificing performance. For example, the non-contiguous attention mask removes the need for memory movement to manage the KV cache buffer. Moreover, the non-contiguous mask decreases CPU load and increases inference speed.

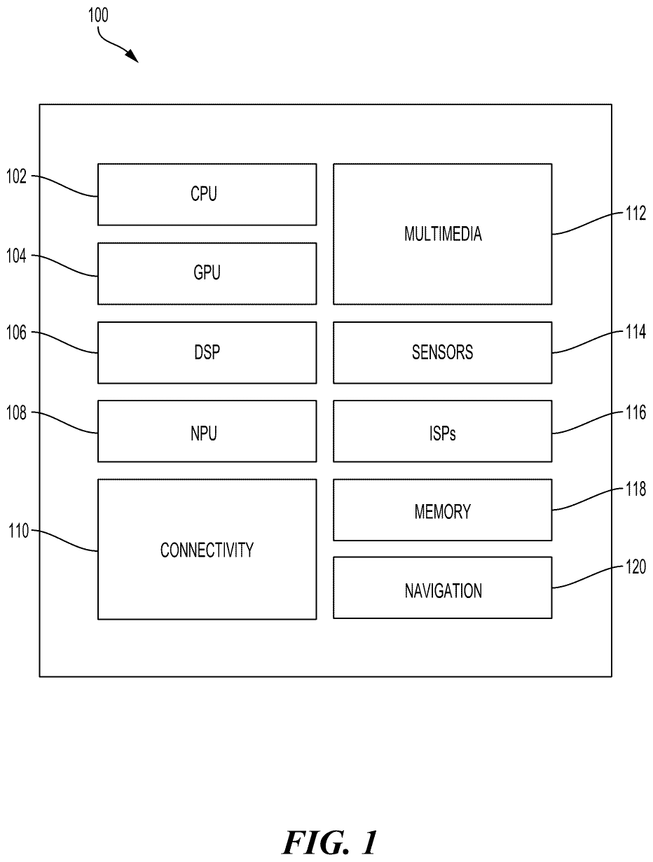

FIG. 1 illustrates an example implementation of a system-on-a-chip (SOC) 100, which may include a central processing unit (CPU) 102 or a multi-core CPU, as well as a graphics processing unit (GPU) 104, and/or a neural processing unit (NPU) 108 configured for constructing and applying a non-contiguous attention mask in a transformer model. Variables (e.g., neural signals and synaptic weights), system parameters associated with a computational device (e.g., neural network with weights), delays, frequency bin information, and task information may be stored in a memory block associated with the NPU 108, in a memory block associated with the CPU 102, in a memory block associated with the GPU 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to construct a non-contiguous attention mask corresponding to selected key-value (KV) vectors non-contiguously stored in a KV cache buffer. The general-purpose processor 102 may also include code to multiply the non-contiguous attention mask with the KV cache buffer to obtain token-specific KV vectors. The general-purpose processor 102 may further include code to generate a new KV vector, with an artificial neural network transformer model during a current inference iteration, based on an input token and the token-specific KV vectors. In some aspects, the general-purpose processor 102 may include means to construct, means to multiply, means to generate, means to append, means to concurrently generate, means to select, means to verify, and means to update.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

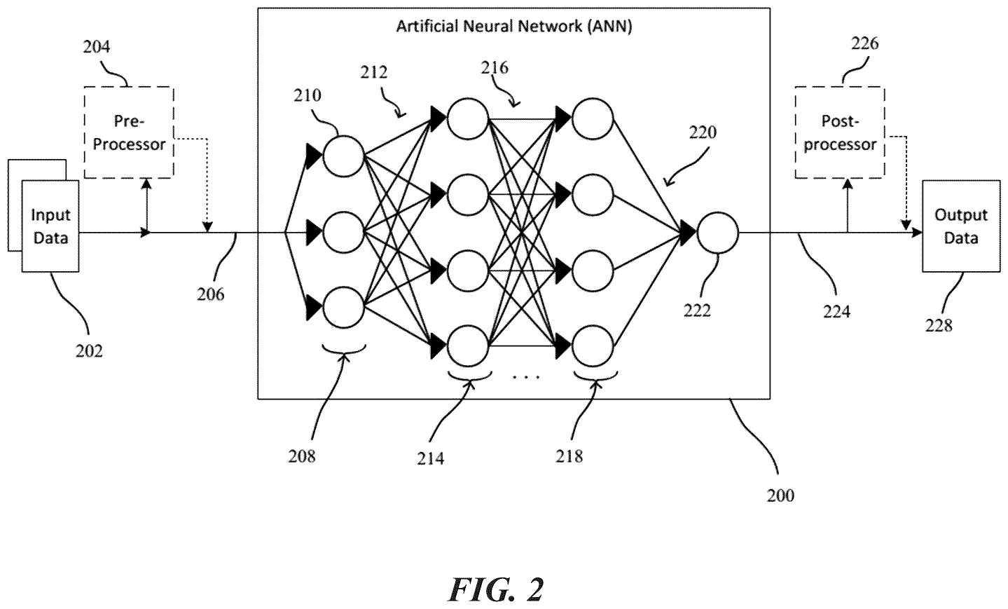

FIG. 2 is an illustrative block diagram of an example machine learning (ML) model represented by an artificial neural network (ANN) 200. The ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of the ANN 200. A pre-processor 204 may be included within the ANN 200 in some other implementations. The pre-processor 204 may, for example, process all or a portion of the data 202, which may result in some of the data 202 being changed, replaced, deleted, etc. In some implementations, the pre-processor 204 may add additional data to the data 202.

The ANN 200 includes at least one first layer 208 of artificial neurons 210 to process input data 206 and provide resulting first layer data via connections or “edges” such as the edges 212 to at least a portion of at least one second layer 214. The second layer 214 processes data received via the edges 212 and provides second layer output data via the edges 216 to at least a portion of at least one third layer 218. The third layer 218 processes data received via the edges 216 and provides third layer output data via the edges 220 to at least a portion of a final layer 222 including one or more neurons to provide output data 224. All or part of the output data 224 may be further processed in some manner by an optional post-processor 226. Thus, in certain examples, the ANN 200 may provide output data 228 that is based on output data 224, post-processed data output from the post-processor 226, or some combination thereof.

The post-processor 226 may be included within the ANN 200 in some other implementations. The post-processor 226 may, for example, process all or a portion of the output data 224 which may result in the output data 228 being different, at least in part, to the output data 224, as result of data being changed, replaced, deleted, etc. In some implementations, the post-processor 226 may be configured to add additional data to the output data 224. In this example, the second layer 214 and third layer 218 represent intermediate or hidden layers arranged in a hierarchical or other like structure. Although not explicitly shown, there may be one or more further intermediate layers between the second layer 214 and the third layer 218.

The structure and training of artificial neurons 210 in the various layers may be tailored to specific requirements of an application. Within a given layer such as the first layer 208, second layer 214, or third layer 218 of the ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 200. The weights and biases of the ANN 200 may be adjusted during a training process or during operation of the ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 200, may be conducted using training data. Training data may include one or more datasets the ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may repeat multiple times to fine-tune the ANN 200 with each iteration.

Various ANN model structures are available for consideration. For example, in a feed-forward ANN structure, each artificial neuron 210 in layer 214 receives information from the previous layer (such as, one or more artificial neurons 210 in layer 208) and produces information for the next layer (such as, one or more artificial neurons 210 in layer 218). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feed-forward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing, such as text generation. A large language model may be a particularly useful implementation of a transformer ANN structure.

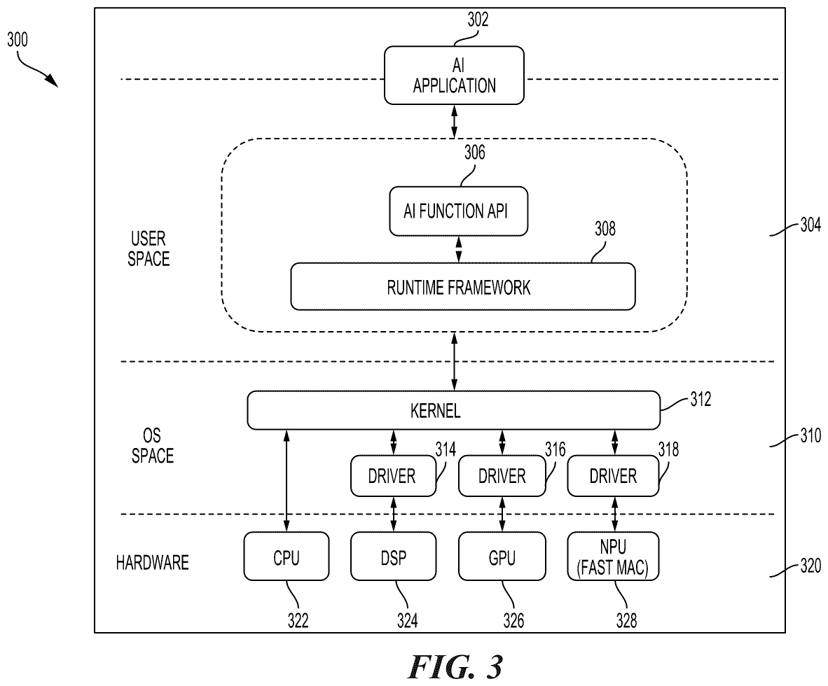

FIG. 3 is a block diagram illustrating an exemplary software architecture 300 that may modularize artificial intelligence (AI) functions. Using the architecture 300, applications may be designed that may cause various processing blocks of an SOC 320 (for example a CPU 322, a DSP 324, a GPU 326 and/or an NPU 328) (which may be similar to SOC 100 of FIG. 1) to construct a non-contiguous attention mask corresponding to selected key-value (KV) vectors non-contiguously stored in a KV cache buffer for an AI application 302, according to aspects of the present disclosure. Applications may be designed that may cause various processing blocks of an SOC 320 (for example a CPU 322, a DSP 324, a GPU 326 and/or an NPU 328) (which may be similar to SOC 100 of FIG. 1) to multiply the non-contiguous attention mask with the KV cache buffer to obtain token-specific KV vectors for an AI application 302, according to aspects of the present disclosure. Applications may be designed that may cause various processing blocks of an SOC 320 (for example a CPU 322, a DSP 324, a GPU 326 and/or an NPU 328) (which may be similar to SOC 100 of FIG. 1) to generate a new KV vector, with an artificial neural network transformer model during a current inference iteration, based on an input token and the token-specific KV vectors for an AI application 302, according to aspects of the present disclosure. The architecture 300 may, for example, be included in a computational device, such as a smartphone.

The AI application 302 may be configured to call functions defined in a user space 404 that may, for example, provide for text, video, and/or sound generation. The AI application 302 may make a request to compiled program code associated with a library defined in an AI function application programming interface (API) 306. This request may ultimately rely on the output of a deep neural network configured to provide an inference response based on input, for example.

The run-time engine 308, which may be compiled code of a runtime framework, may be further accessible to the AI application 302. The AI application 302 may cause the run-time engine 308, for example, to request an inference at a particular time interval or triggered by an event detected by the user interface of the AI application 302. When caused to provide an inference response, the run-time engine 308 may in turn send a signal to an operating system in an operating system (OS) space 310, such as a Kernel 312, running on the SOC 320. In some examples, the Kernel 312 may be a LINUX Kernel. The operating system, in turn, may cause non-contiguous attention masks to be processed on the CPU 322, the DSP 324, the GPU 326, the NPU 328, or some combination thereof. The CPU 322 may be accessed directly by the operating system, and other processing blocks may be accessed through a driver, such as a driver 314, 316, or 318 for, respectively, the DSP 324, the GPU 326, or the NPU 328. In the exemplary example, the deep neural network may be configured to run on a combination of processing blocks, such as the CPU 322, the DSP 324, and the GPU 326, or may be run on the NPU 328.

Large language model (LLM) token generation requires the use of a key-value cache (KV$) to store intermediate calculations. Due to the static nature of existing compiler frameworks, the KV cache has been implemented as a left-padded buffer. Adding newly generated KV vectors to the buffer requires a left-shift of the existing buffer, either by pointer manipulation or direct memory movement operations (e.g., the command ‘std::memmove’).

Aspects of the present disclosure bypass the need for a left-padded buffer by utilizing a specially designed attention mask. A properly designed attention mask allows for non-contiguous KV cache tensors without any loss in precision or accuracy.

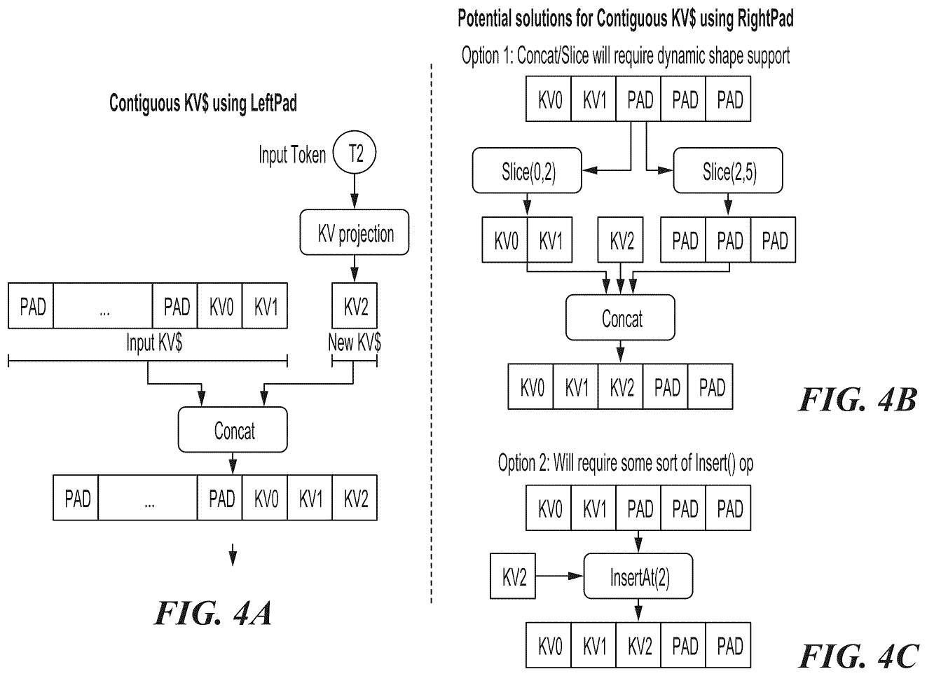

FIG. 4A illustrates a technique for creating a contiguous key-value (KV) cache with left padding. In the example of FIG. 4A, the large language model has a context length of less than ten for ease of explanation. Padding cells (PAD) and valid KV vectors (KV0, KV1) are present in an input KV cache (KV$). A model inference (KV projection) is based on an input token T2 to generate a new KV vector KV2 in an output KV cache. A concatenation operation (Concat) concatenates the new KV vector KV2 with the past context values (KV0, KV1) in the input KV cache to create a concatenated KV cache tensor.

The left-padding design is based on the internals of the transformer architecture. As seen in FIG. 4A, the past context (KV0, KV1) is passed in as an input KV$, and internally concatenated with the output KV$ generated by processing input tokens. In the example of FIG. 4A, all valid KV vectors are assumed to be in contiguous memory after concatenation.

With this assumption, a right padding design requires either dynamic shape support or insertion at an arbitrary index. FIG. 4B illustrates a first option for creating a contiguous KV cache with right padding. The first option includes dynamic shape support such that slice operations occur at specific indexes (e.g., (0,2) and (2,5)) followed by a concatenation operation.

FIG. 4C illustrates a second option for creating a contiguous KV cache with right padding. As shown in FIG. 4C, insertion occurs at an arbitrary index. In the example of FIG. 4C, the KV vector KV2 is inserted with an insert operation that specifically indicates a location for insertion (location 2 in this example).

Input and output tensors require buffer allocation space. To save memory, the model emits only the newly generated KV vectors instead of the concatenated KV cache tensor. KV cache management involves managing the buffer for the input KV cache, including concatenating the output KV vector. Two solutions are available to obtain a left padding design, in which all padding is on the left side of the buffer.

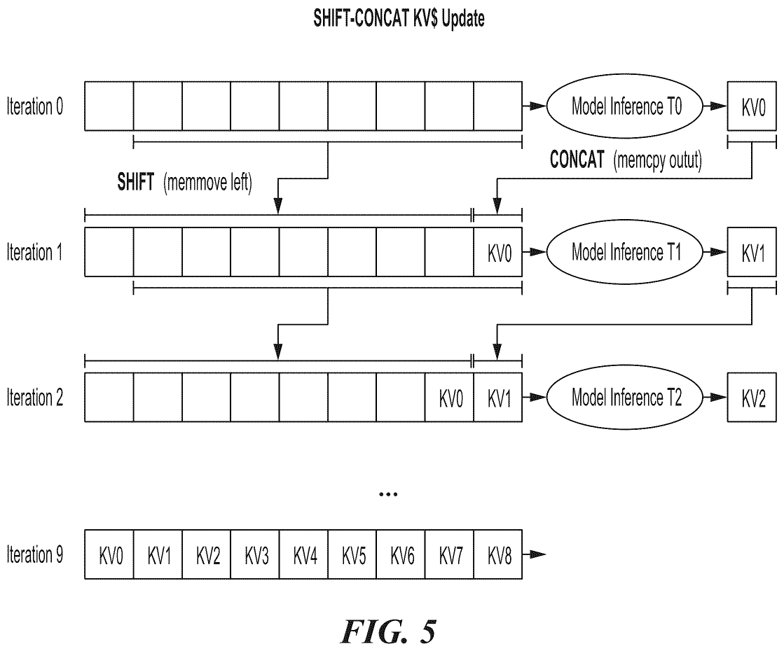

FIG. 5 illustrates a first technique for creating a contiguous cache with left padding. In the example of FIG. 5, at iteration 0, the transformer model generates an inference based on input token T0 to generate a new KV vector KV0. At iteration 1, the KV cache is shifted left using a memory shift operation (e.g., std::memmove). The resulting space on the right side is filled by concatenating the output KV cache, which includes the new KV vector KV0. The process repeats for multiple iterations (ten iterations in the example of FIG. 5) until the KV vectors KV0, KV1, KV2, KV3, KV4, KV5, KV6, KV7, and KV8 are loaded in the input KV cache at iteration 9. Unfortunately, this process causes a high CPU load.

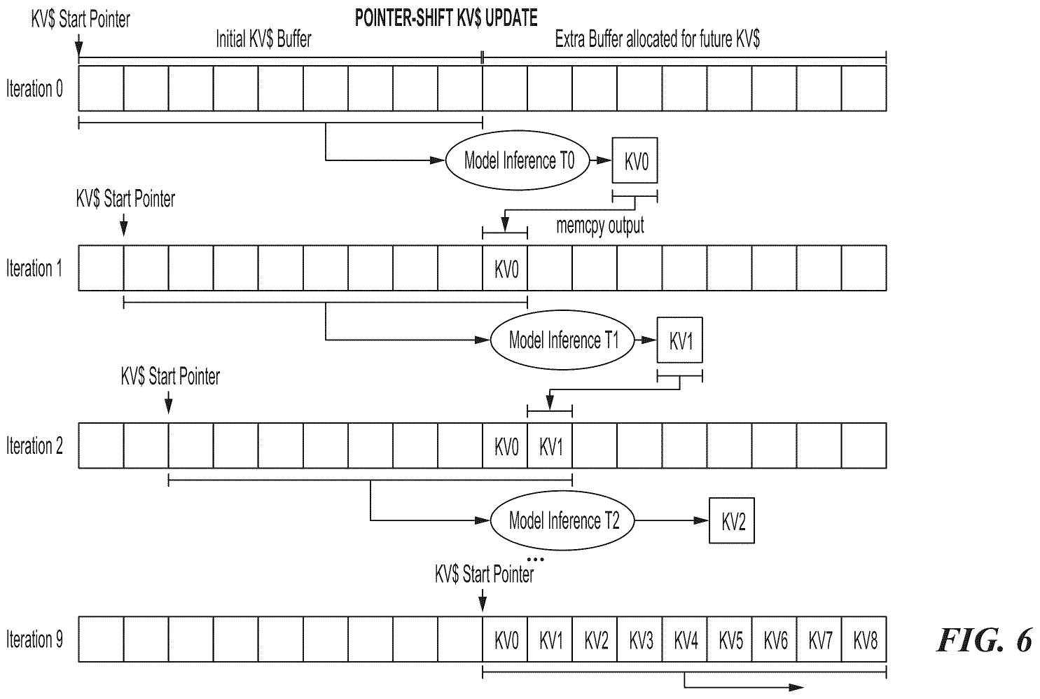

FIG. 6 illustrates a second technique for creating a contiguous cache with left padding: a pointer shift. A pointer shift technique avoids the need to move the entire KV cache left by allocating extra space at the end of the KV cache buffer. Instead of shifting all KV vectors left, the buffer start pointer shifts to the right.

FIG. 6 shows a simplified version of the process where the actual space allocated is proportionally much smaller than in practice. For the large language model llama2-7B using an 8-bit KV cache and 1024 max context length, each key-cache tensor requires ˜1024 (maximum size of the prompt and output (ctx_size)) extra bytes, while each value-cache tensor requires ˜1024*128 (ctx_size*total dimension of the model (embed_dim)) extra bytes. Over 32 layers, this results in ˜32*1024+32*1024*128 bytes ˜4.25 MB of data.

As seen in FIG. 6, a KV$ start pointer moves right at each iteration when a new KV vector is inserted. Extra buffer space is allocated to accommodate insertion of the new KV vectors generated by the model inference.

Pointer shift requires a relatively small amount of extra memory and eliminates the CPU load of moving the entire KV cache each iteration. However, updating the start pointers requires computation for memory validations (e.g., using memRegister/memDeRegister calls between the CPU and NPU). This CPU load is required to update the pointers for all the input tensors, making this technique unviable in the case of many input/output (I/O) tensors (e.g., unbundled models have an output key/value tensor for each head for each layer. For the large language model Llama2-7B, there can be 32 layers*32 heads key and 32*32 value tensors).

Aspects of the present disclosure introduce an efficient technique for implementing a right-padded buffer instead of a left-padded buffer. The right-padded buffer allows for an intuitive filling of the KV cache from left to right without any extra memory movement or pointer shifts.

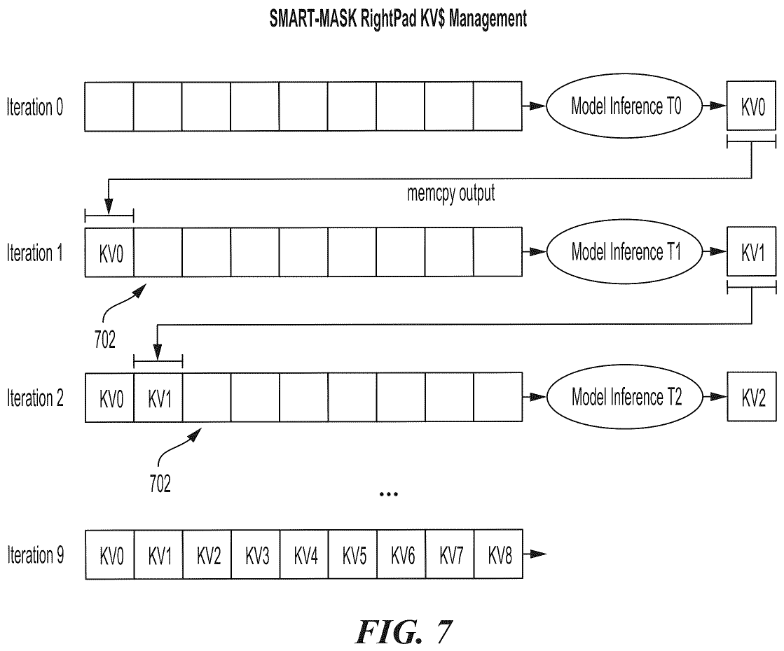

FIG. 7 illustrates right padding KV cache management, in accordance with aspects of the present disclosure. In the example of FIG. 7, at iteration 0, a model inference based on a first input token TO generates a new KV vector KV0. At iteration 1, the new KV vector KV0 is appended to the input KV cache, with all padding 702 located to the right of the new KV vector KV0. A model inference based on a next input token T1 generates a new KV vector KV1. It is noted that the KV vectors KV0 and KV1 are non-contiguous, due to the padding 702 between the KV vectors KV0 and KV1.

At iteration 2, the new KV vector KV1 is appended to the input KV cache, with all padding 702 located to the right of the new KV vector KV1. A model inference based on a next input token T2 generates a new KV vector KV2. It is noted that the KV vectors KV0, KV1, and KV2 are non-contiguous, due to the padding 702 between the KV vectors KV2 and KV1.

The process repeats until iteration 9, where the input KV cache stores the KV vectors KV0, KV1, KV2, KV3, KV4, KV5, KV6, KV7, and KV8.

According to aspects of the present disclosure, right padding is enabled by construction of an attention mask. As with prior techniques, each token only attends to itself and its past context (e.g., Ty attends to KV₀, KV₁, . . . , KVₙ₋₁). According to these aspects of the present disclosure, the attention mask is non-contiguous.

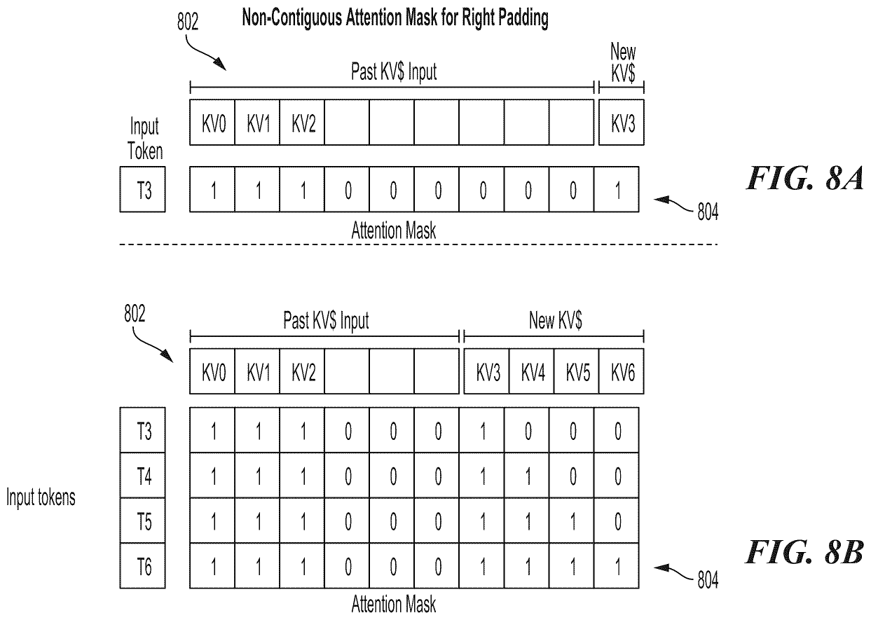

FIG. 8A is a block diagram illustrating a non-contiguous attention mask for right padding, according to aspects of the present disclosure. In the example of FIG. 8A, a concatenated KV cache 802 stores past KV vectors (KV0, KV1, KV2) received as input plus a new KV vector (KV3) generated from an input token T3. The past KV vectors (KV0, KV1, KV2) in the concatenated KV cache 802 are stored in an input buffer portion of the KV cache 802. The new KV vector (KV3) of the concatenated KV cache is stored in an output buffer portion of the KV cache 802. Each cell in an attention mask 804 may be set to 1 if the corresponding token (e.g., T3) attends to the corresponding KV vector (e.g., KV0, KV1, etc.) in the KV cache 802. Each cell in the attention mask 804 may be set to 0 if the corresponding token (e.g., T3) does not attend to the corresponding KV vector (e.g., KV0, KV1, etc.) in the KV cache 802. The attention mask has a size of [number of input tokens*context length]. The non-contiguous attention mask 804 allows non-contiguous KV vectors in the KV cache 802 without sacrificing performance.

FIG. 8B is a block diagram illustrating a non-contiguous attention mask for right padding, according to aspects of the present disclosure. In the example of FIG. 8B, a concatenated KV cache 802 stores past KV vectors (KV0, KV1, KV2) received as input plus new KV vectors (KV3, KV4, KV5, KV6) generated from the input tokens T3, T4, T5, T6. The past KV vectors (KV0, KV1, KV2) in the concatenated KV cache are stored in an input buffer portion of the KV cache 802. The new KV vectors (KV3, KV4, KV5, KV6) of the concatenated KV cache 802 are stored in an output buffer portion of the KV cache 802. Each cell in an attention mask 804 may be set to 1 if the corresponding tokens (e.g., T3, T4, T5, T6) attend to the corresponding KV vectors (e.g., KV0, KV1, etc.) in the KV cache 802. Each cell in the attention mask 804 may be set to 0 if the corresponding tokens (e.g., T3, T4, T5, T6) do not attend to the corresponding KV vector (e.g., KV0, KV1, etc.) in the KV cache 802.

The non-contiguous mask allows non-contiguous KV vectors in the KV cache without sacrificing performance. For example, the non-contiguous attention mask removes the need for memory movement to manage the KV cache buffer. Memory movement only occurs when copying the new KV vector into the KV cache buffer. The non-contiguous mask decreases CPU load and increases inference speed. The non-contiguous mask removes operations, such as memmove and memRegister/memDeRegister, and does not require any extra space. The non-contiguous mask works on both bundled and unbundled models.

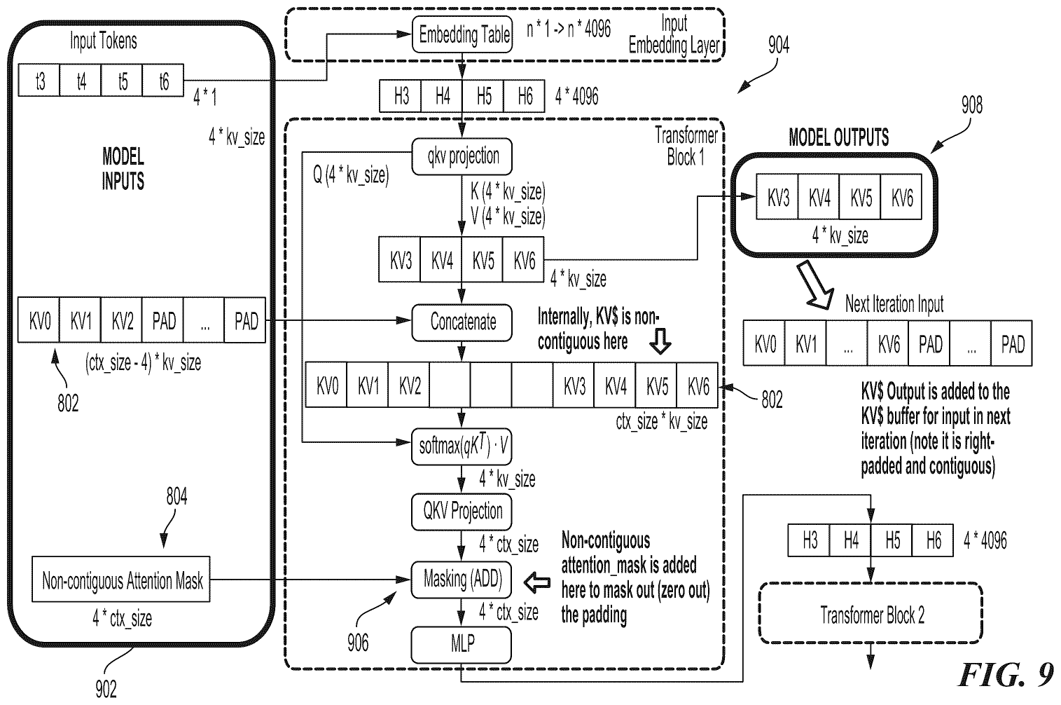

FIG. 9 is a block diagram illustrating transformer model inputs and outputs, and masking by a non-contiguous attention mask, in accordance with aspects of the present disclosure. In the example of FIG. 9, model inputs 902 to a transformer model 904 include input tokens, a right padded KV cache 802 and a non-contiguous attention mask 804. The transformer model 904 includes a layer 906 that implements the non-contiguous attention mask 804 to mask out padding from the KV cache 802. It is noted that internally, within the transformer model 904, the KV cache 802 is non-contiguous. Model outputs 908 are added to the KV cache 802 for input in the next iteration. It is noted that the KV cache 802 is right padded and contiguous outside of the transformer model 904.

A non-contiguous KV cache enables multi-stream token generation. Multi-stream token generation implements a design to allow generation of up to n concurrent output streams. The multi-stream approach effectively emulates n-token batching (e.g., using batch-n models) with the usage of AR-n models (auto-regressive models that process n input tokens at a time) and careful usage of the attention mask. The process is as follows. First, the prompt is processed, and the KV cache is updated in a standard manner. The probability distribution output (e.g., the logit tensor) generated by prompt processing is sampled to produce a quantity (e.g., (4) four) potential tokens using a probabilistic sampling function. This step is model-agnostic. The generated tokens are run through the model. The attention mask for each token is set to only attend to the prompt tokens and itself. The model outputs a [4, vocab_size] logit tensor. In this example, four is selected, but any number is possible. Each [vocab_size] vector represents the logits for one output stream, and can be sampled independently to produce the next token in its stream. The KV cache is updated with all four newly generated KV cache values. The KV cache history includes the prompt KV cache, followed by the KV cache from all the output streams interleaved together. The generated tokens are run through the model. The attention mask for each token is set to only attend to the prompt tokens, the previous tokens in its output stream, and itself. These steps are repeated until all streams hit an end of stream (EOS) or the context length is reached. In some aspects, once a stream hits EOS, the implementation runs only the remaining streams, avoiding consuming the KV cache size limit for completed streams. These aspects potentially allow for longer text generation for the remaining streams.

For multi-stream token generation, multiple input tokens (e.g., T3, T4, T5, T6 from FIG. 8A) may operate in parallel on different sets of data from the KV cache. For example, input token T3 may operate on KV vectors KV0, KV1, KV2, and KV3, whereas input token T4 may operate on KV vectors KV0, KV1, KV2, and KV4. Each stream of tokens only attends to the past KV vectors from its own stream, allowing multiple independent streams of text to be generated concurrently without any impact on other streams or overall latency.

A non-contiguous KV cache also enables multiple probable token testing to determine which token should be used next. Multiple tokens may be independently processed, along with the current context, at the same time. The probability distribution output (e.g., the logit tensor) may be sampled to select the best result with the highest confidence level. The multiple probable token testing may boost accuracy rates without any loss in latency.

A non-contiguous KV cache further enables draft model support. For speculative decoding, a small draft model may generate several speculative tokens, which are then verified using a larger target model. When tokens are rejected, the KV vector is discarded, requiring expensive memory operations. According to aspects of the present disclosure, a non-contiguous cache can mark the KV vector as discarded, without loss of accuracy or extra CPU load for clearing the memory. For example, if the model decides to rewind back to a prior state (e.g., ignoring most recent KV vectors (e.g., KV6 and KV5), the corresponding elements in the non-contiguous attention mask may be set to empty (e.g., 0).

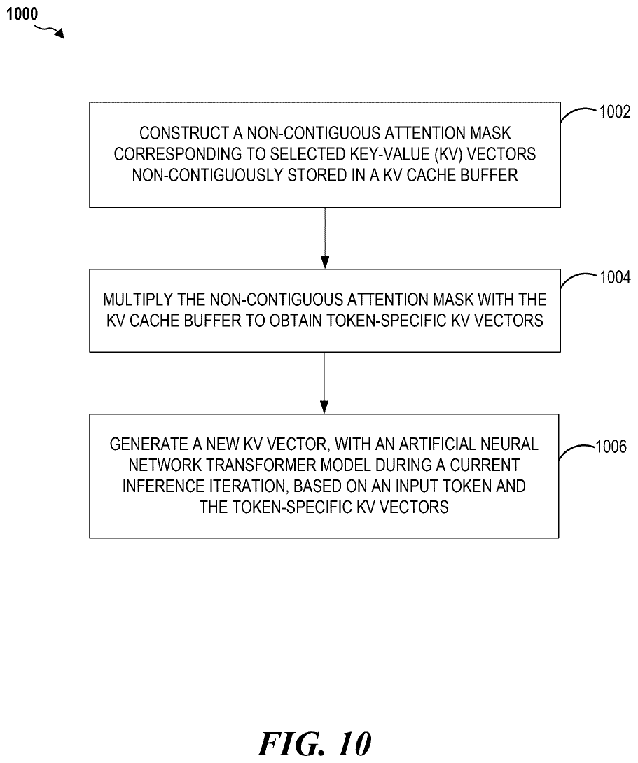

FIG. 10 is a flow diagram illustrating a processor-implemented method 1000 for operating a transformer model with a non-contiguous attention mask, in accordance with various aspects of the present disclosure. The processor-implemented method 1000 may be performed by one or more processors such as the CPU (e.g., 102, 422), GPU (e.g., 104, 426), and/or other processing unit (e.g., DSP 424, NPU 428), for example. As shown in FIG. 10, in some aspects, the processor-implemented method 1000 may include constructing a non-contiguous attention mask corresponding to selected key-value (KV) vectors non-contiguously stored in a KV cache buffer (block 1002). For example, the non-contiguous attention mask may have a size corresponding to a number of input tokens multiplied by a context length.

In some aspects, the processor-implemented method 1000 may include multiplying the non-contiguous attention mask with the KV cache buffer to obtain token-specific KV vectors (block 1004). In some aspects, the processor-implemented method 1000 may include generating a new KV vector, with an artificial neural network transformer model during a current inference iteration, based on an input token and the token-specific KV vectors (block 1004). For example, in some aspects, the process concurrently generates multiple independent streams of new KV vectors, with the artificial neural network transformer model during a single inference iteration, based on a plurality of independent streams of input tokens and a plurality of token-specific KV vectors, which are determined by the non-contiguous attention mask. In still further aspects, the process appends the new KV vector into an input buffer of the KV cache buffer adjacent to right-side padding during a next inference iteration with the artificial neural network transformer model.

### EXAMPLE ASPECTS

Aspect 1: A processor-implemented method, comprising: constructing a non-contiguous attention mask corresponding to selected key-value (KV) vectors non-contiguously stored in a KV cache buffer; multiplying the non-contiguous attention mask with the KV cache buffer to obtain token-specific KV vectors; and generating a new KV vector, with an artificial neural network transformer model during a current inference iteration, based on an input token and the token-specific KV vectors.

Aspect 2: The method of Aspect 1, further comprising appending the new KV vector into an input buffer of the KV cache buffer adjacent to right-side padding during a next inference iteration with the artificial neural network transformer model.

Aspect 3: The method of Aspect 1 or 2, in which the non-contiguous attention mask has a size corresponding to a number of input tokens multiplied by a context length.

Aspect 4: The method of any of the preceding Aspects, further comprising concurrently generating a plurality of independent streams of new KV vectors, with the artificial neural network transformer model during a single inference iteration, based on a plurality of independent streams of input tokens and a plurality of token-specific KV vectors, which are determined by the non-contiguous attention mask.

Aspect 5: The method of any of the preceding Aspects, further comprising selecting an output from the plurality of new KV vectors based on confidence levels of each of the plurality of new KV vectors, the selected output having a highest confidence level.

Aspect 6: The method of any of the preceding Aspects, further comprising: verifying whether speculative input tokens are to be discarded; and updating the non-contiguous attention mask to mark selected KV vectors that are to be discarded based on the verifying.

Aspect 7: An apparatus, comprising: at least one memory; and at least one processor coupled to the at least one memory, the at least one processor configured: to construct a non-contiguous attention mask corresponding to selected key-value (KV) vectors non-contiguously stored in a KV cache buffer; to multiply the non-contiguous attention mask with the KV cache buffer to obtain token-specific KV vectors; and to generate a new KV vector, with an artificial neural network transformer model during a current inference iteration, based on an input token and the token-specific KV vectors.

Aspect 8: The apparatus of Aspect 7, in which the at least one processor is further configured to append the new KV vector into an input buffer of the KV cache buffer adjacent to right-side padding during a next inference iteration with the artificial neural network transformer model.

Aspect 9: The apparatus of Aspect 7 or 8, in which the non-contiguous attention mask has a size corresponding to a number of input tokens multiplied by a context length.

Aspect 10: The apparatus of any of the Aspects 7-9, in which the at least one processor is further configured to concurrently generate a plurality of independent streams of new KV vectors, with the artificial neural network transformer model during a single inference iteration, based on a plurality of independent streams of input tokens and a plurality of token-specific KV vectors, which are determined by the non-contiguous attention mask.

Aspect 11: The apparatus of any of the Aspects 7-10, in which the at least one processor is further configured to select an output from the plurality of new KV vectors based on confidence levels of each of the plurality of new KV vectors, the selected output having a highest confidence level.

Aspect 12: The apparatus of any of the Aspects 7-11, in which the at least one processor is further configured: to verify whether speculative input tokens are to be discarded; and to update the non-contiguous attention mask to mark selected KV vectors that are to be discarded based on the verifying.

Aspect 13: A non-transitory computer-readable medium having program code recorded thereon, the program code executed by a processor and comprising: program code to construct a non-contiguous attention mask corresponding to selected key-value (KV) vectors non-contiguously stored in a KV cache buffer; program code to multiply the non-contiguous attention mask with the KV cache buffer to obtain token-specific KV vectors; and program code to generate a new KV vector, with an artificial neural network transformer model during a current inference iteration, based on an input token and the token-specific KV vectors.

Aspect 14: The non-transitory computer-readable medium of Aspect 13, in which the program code comprises program code to append the new KV vector into an input buffer of the KV cache buffer adjacent to right-side padding during a next inference iteration with the artificial neural network transformer model.

Aspect 15: The non-transitory computer-readable medium of Aspect 13 or 14, in which the non-contiguous attention mask has a size corresponding to a number of input tokens multiplied by a context length.

Aspect 16: The non-transitory computer-readable medium of any of the Aspects 13-15, in which the program code comprises program code to concurrently generate a plurality of independent streams of new KV vectors, with the artificial neural network transformer model during a single inference iteration, based on a plurality of independent streams of input tokens and a plurality of token-specific KV vectors, which are determined by the non-contiguous attention mask.

Aspect 17: The non-transitory computer-readable medium of any of the Aspects 13-16, in which the program code comprises program code to select an output from the plurality of new KV vectors based on confidence levels of each of the plurality of new KV vectors, the selected output having a highest confidence level.

Aspect 18: The non-transitory computer-readable medium of any of the Aspects 13-17, in which the program code comprises: program code to verify whether speculative input tokens are to be discarded; and program code to update the non-contiguous attention mask to mark selected KV vectors that are to be discarded based on the verifying.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method, comprising:
constructing a non-contiguous attention mask corresponding to selected key-value (KV) vectors non-contiguously stored in a KV cache buffer;
multiplying the non-contiguous attention mask with the KV cache buffer to obtain token-specific KV vectors; and
generating a new KV vector, with an artificial neural network transformer model during a current inference iteration, based on an input token and the token-specific KV vectors.

2. The method of claim 1, further comprising appending the new KV vector into an input buffer of the KV cache buffer adjacent to right-side padding during a next inference iteration with the artificial neural network transformer model.

3. The method of claim 1, in which the non-contiguous attention mask has a size corresponding to a number of input tokens multiplied by a context length.

4. The method of claim 1, further comprising concurrently generating a plurality of independent streams of new KV vectors, with the artificial neural network transformer model during a single inference iteration, based on a plurality of independent streams of input tokens and a plurality of token-specific KV vectors, which are determined by the non-contiguous attention mask.

5. The method of claim 4, further comprising selecting an output from the plurality of new KV vectors based on confidence levels of each of the plurality of new KV vectors, the selected output having a highest confidence level.

6. The method of claim 1, further comprising:
verifying whether speculative input tokens are to be discarded; and
updating the non-contiguous attention mask to mark selected KV vectors that are to be discarded based on the verifying.

7. An apparatus, comprising:
at least one memory; and
at least one processor coupled to the at least one memory, the at least one processor configured:
to construct a non-contiguous attention mask corresponding to selected key-value (KV) vectors non-contiguously stored in a KV cache buffer;
to multiply the non-contiguous attention mask with the KV cache buffer to obtain token-specific KV vectors; and
to generate a new KV vector, with an artificial neural network transformer model during a current inference iteration, based on an input token and the token-specific KV vectors.

8. The apparatus of claim 7, in which the at least one processor is further configured to append the new KV vector into an input buffer of the KV cache buffer adjacent to right-side padding during a next inference iteration with the artificial neural network transformer model.

9. The apparatus of claim 7, in which the non-contiguous attention mask has a size corresponding to a number of input tokens multiplied by a context length.

10. The apparatus of claim 7, in which the at least one processor is further configured to concurrently generate a plurality of independent streams of new KV vectors, with the artificial neural network transformer model during a single inference iteration, based on a plurality of independent streams of input tokens and a plurality of token-specific KV vectors, which are determined by the non-contiguous attention mask.

11. The apparatus of claim 10, in which the at least one processor is further configured to select an output from the plurality of new KV vectors based on confidence levels of each of the plurality of new KV vectors, the selected output having a highest confidence level.

12. The apparatus of claim 7, in which the at least one processor is further configured:
to verify whether speculative input tokens are to be discarded; and
to update the non-contiguous attention mask to mark selected KV vectors that are to be discarded based on the verifying.

13. A non-transitory computer-readable medium having program code recorded thereon, the program code executed by a processor and comprising:
program code to construct a non-contiguous attention mask corresponding to selected key-value (KV) vectors non-contiguously stored in a KV cache buffer;
program code to multiply the non-contiguous attention mask with the KV cache buffer to obtain token-specific KV vectors; and
program code to generate a new KV vector, with an artificial neural network transformer model during a current inference iteration, based on an input token and the token-specific KV vectors.

14. The non-transitory computer-readable medium of claim 13, in which the program code comprises program code to append the new KV vector into an input buffer of the KV cache buffer adjacent to right-side padding during a next inference iteration with the artificial neural network transformer model.

15. The non-transitory computer-readable medium of claim 13, in which the non-contiguous attention mask has a size corresponding to a number of input tokens multiplied by a context length.

16. The non-transitory computer-readable medium of claim 13, in which the program code comprises program code to concurrently generate a plurality of independent streams of new KV vectors, with the artificial neural network transformer model during a single inference iteration, based on a plurality of independent streams of input tokens and a plurality of token-specific KV vectors, which are determined by the non-contiguous attention mask.

17. The non-transitory computer-readable medium of claim 16, in which the program code comprises program code to select an output from the plurality of new KV vectors based on confidence levels of each of the plurality of new KV vectors, the selected output having a highest confidence level.

18. The non-transitory computer-readable medium of claim 13, in which the program code comprises:
program code to verify whether speculative input tokens are to be discarded; and
program code to update the non-contiguous attention mask to mark selected KV vectors that are to be discarded based on the verifying.
